(19) United States
(12) Patent Application Publication
(10) Pub. No.: US 2019/0370353 A1
(43) Pub. Date: Dec. 5, 2019

(54) CHANGE NOTIFICATIONS FOR OBJECT STORAGE

(71) Applicant: Microsoft Technology Licensing, LLC, Redmond, WA (US)

(72) Inventors: Sandesh DODDAMETI, Seattle, WA (US); Jegan DEVARAJU, Redmond, WA (US); Himanshu GUPTA, Seattle, WA (US); Maneesh SAH, Sammamish, WA (US)

(21) Appl. No.: 15/991,039

(22) Filed: May 29, 2018

(51) Int. Cl. G06F 17/30; H04L 29/08

(52) U.S. Cl. CPC G06F 17/30144; G06F 17/30194; H04L 67/1097; H04L 67/26

(57) ABSTRACT

Provides is a system and method for tracking changes in object storage and pushing notifications of the changes to client systems. In one example, the method may include detecting a change within a cloud storage based on an unstructured storage object stored in the cloud storage, identifying contextual attributes of the change from an updated state of a log file that stores information about the unstructured storage object, generating a notification that indicates the detected change and the identified contextual attributes of the detected change, and transmitting the generated notification message to one or more recipients associated with the unstructured storage object.

### BACKGROUND

Cloud storage enables data to be stored on the Internet at a remote site rather than, or in addition to, storing data on-premises. Cloud storage typically refers to an object storage service or system. In some cases, cloud storage may offer a massively scalable object storage system for data objects, a file system service for the cloud, a messaging store for reliable messaging, and the like. Redundancy within cloud storage may ensure that data is safe in the event of transient hardware failures. Further, data may be replicated across datacenters or geographical regions of the cloud storage for additional protection.

For providers, cloud storage may include a multi-tenant environment which stores many objects (e.g., hundreds, thousands, millions, etc.) within the object storage system. For example, objects may be used to store files, images, documents, and the like, in an unstructured format. Objects may be updated by users, software, and systems, with authorized access to such objects. In this environment, it may be beneficial for a client to understand what and how their data is being accessed. However, when changes are made to an object, the only indicator is typically in the form of a timestamp which identifies a point in time at which the object was most recently modified or added. The timestamp does not provide any context about the object. Furthermore, for the user to view the timestamp information the user often has to access a storage file/container and view objects on a line-by-line basis to locate an identifier of the desired object. Accordingly, what is needed is an improved mechanism for tracking and providing notice of changes within an object storage.

### BRIEF DESCRIPTION OF THE DRAWINGS

FIG. 1 is diagram illustrating a cloud environment for generating object storage notifications according to some embodiments.

FIG. 2 is a diagram illustrating an object storage architecture for a cloud environment according to some embodiments.

FIG. 3 is a diagram illustrating a change log for use in tracking context of object changes according to some embodiments.

FIG. 4A is a diagram illustrating a publish and subscribe system for transmitting notifications according to some embodiments.

FIG. 4B is a diagram illustrating a notifications processor which may be included within the public subscribe system of FIG. 4A, according to some embodiments.

FIG. 5 is a diagram illustrating a method for generating and transmitting notifications for an object storage according to some embodiments.

FIG. 6 is a diagram illustrating an example of a computing node architecture according to some embodiments.

### DETAILED DESCRIPTION

The following description is provided to enable any person in the art to make and use the described embodiments. Various modifications, however, will remain readily-apparent to those in the art.

Related attempts to provide notice of changes within an object storage rely on non-transactional, non-durable methods which are subject to loss. For example, a live-send and catch-up process can be performed using a buffer. This process involves a complicated checkpoint operation and suffers data loss when the limited size buffer space is exceeded. As another example, a user may view changes to an object storage through an in-line listing of objects within a container or file directory. Here, the user may perform a look-up of a list of objects and timestamp information. This process, however, only provides the user with a time of a lasted change to the object or a time when the object was added to the system. Furthermore, none of the related processes provide context of changes to an object storage.

The example embodiments overcome the above-mentioned deficiencies by providing a notification system for cloud storage. The notification system may track and notify subscribers of changes that occur to objects within an object storage of the cloud environment. A change log may be used to track events as they occur and to accumulate event data over time. The notification system may manage the change log within the object storage and generate notifications that are handled by an event grid. The event grid may route the notifications to one or more subscriber systems which have registered to receive notifications for an account associated with the object. The change log may further identify contextual information about the changes made to the object. For example, the context may include information about who/what made the change, a type of change, a sequence/order=of changes, and the like. Furthermore, the notifications may be pushed to subscribers via an at-least once, lossless, protocol that is designed to be resilient to failures. Accordingly, the notifications system is designed to capture and communicate changes in the presence of any internal or externally-perceived failures with the at-least once guarantee.

The example embodiments may be implemented as part of a binary large object (blob) storage. The architecture of the system can capture a change to blob objects (as an event) and metadata of the change in a durable and lossless manner. The system can guarantee at-least once delivery of a notification of the captured change in real-time. The system can be scaled to accommodate problems for a large scale distributed storage system. The system is also capable of being implemented within a multi-tenant public cloud service system in which the blob storage is shared among disparate producers and independent owner spaces and where notifications of changes may be destined or processed by independent consumers with varying degrees of availability.

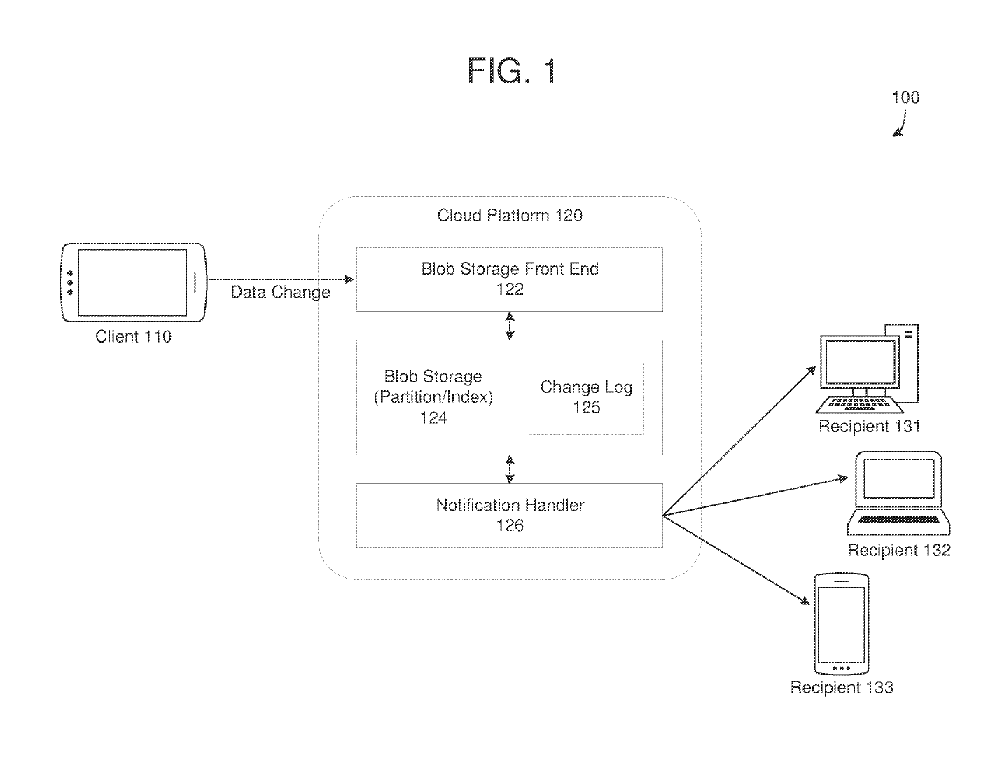

FIG. 1 illustrates a cloud environment 100 for generating object storage notifications according to some embodiments. In this example, the object storage is a blob storage. Blobs enable retention of large amounts of unstructured data and typically include the data itself, metadata of the data, one or more identifiers of the blob, and the like. Referring to FIG. 1, the cloud environment 100 includes a cloud platform 120 which may implement the blob storage system. The cloud platform includes a blob storage front end 122, a storage 124 (also referred to as a partition layer) which may include partitions of storage for storing blobs, files, tables, and the like, and a notification handler 126. A client 110 may modify data stored within the storage 124. For example, the client 110 may add a new blob, modify/change an existing blob, delete a blob, and the like, via a request that is sent to the blob storage front-end 122. In response, the blob storage front-end 122 may trigger a requested change to a blob stored within the storage 124.

Changes to, deletions, and additions within the storage 124 may be recorded within a change log 125 which may also be stored within the partition layer. Changes may be stored as events which identify a location of the blob within the partition layer of the storage 124, an account associated with the blob being changed, a timestamp of the change, metadata of the change, context of the change, and the like. The changes stored within the change log 125 may be read by the storage 124 on-demand or at intervals to create notifications. For example, each detected change to a blob may cause the storage 124 to generate a notification. As another example, changes to one or more blobs may be accrued over time and transmitted as notifications when a threshold or a condition is met. As another example, notifications may be sent on periodic or random basis to provide a snapshot or window of changes over an interval of time (e.g., since the last notification was sent, etc.).

The storage 124 may build a notification message and send the notification message to the notification handler 126. The notification handler 126 may an event grid or an event handler which receives notifications from a notification processor of the storage 124 and schedules and forwards the notifications to subscribers 131, 132, and 133. For example, the notification handler 126 may identify one or more subscribers of a blob, and generate notifications for each subscriber in response to a change being detected with respect to the blob. Different subscribers may have customized and different notification parameters and endpoints. In the example of FIG. 1, subscribers 131, 132, and 133 are shown and receive notifications from the notification handler 126. In this example, the subscribers 131, 132, and 133 are shown as devices, however, it should be appreciated that the subscribers may be software instead of or in addition to the devices (e.g., an application, a service, etc.)

To enable notifications, the client 110 may register with the blob storage front-end 122 thereby configuring the client account for notifications. When a change occurs to a blob stored with respect to this account, the cloud platform 120 may generate and transmit notifications of the change to any interested subscribers. The client 110 may generate a change to a blob (or create a new blob) by submitting a request to an application programming interface (API) of the blob storage front-end 122. The request may identify the blob to be changed via a put blob request which identifies an account, a key, a blob, and the like. The blob storage 124 may receive and perform the change. Furthermore, the blob storage 124 may record the change within the change log 125. Notifications may be generated when the storage 124 reads the change log 125, identifies new changes, and builds notifications for such changes. For example, the notification message may identify the blob account, the key, the action/event of the change, and the like. The notification message may be provided to the notification handler 126 which identifies any subscribers to the account associated with the notification message/change and transmits the notification message to the identified subscribers.

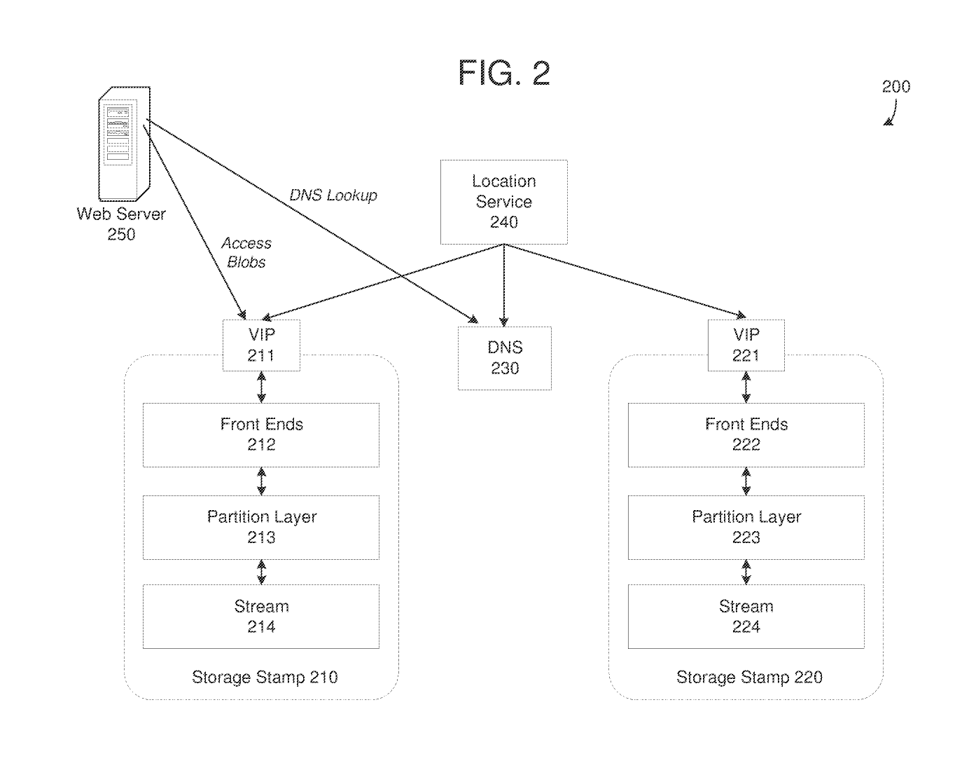

FIG. 2 illustrates an object storage architecture 200 for a cloud environment according to some embodiments. For example, the cloud platform 120 shown in FIG. 1 may be included within a larger architecture such as architecture 200 shown in FIG. 2. Referring to FIG. 2, the architecture 200 includes a plurality of storage stamps (e.g., 210 and 220, etc.) which may be accessed by a server 250 (via a client, etc.) The number of storage stamps is not limited to two but may be more or less. The storage stamps 210 and 220 may each include a front-end 212 and 222, respectively, a partition layer or storage 213 and 223, respectively, and a stream layer 214 and 224, respectively. For convenience, the first storage stamp 210 may be described for purposes of example, but the features thereof may be applied to any storage stamps within the architecture 200 which may include one storage stamp, more than one storage stamp, and the like. The domain name server (DNS) 230 may maintain a directory of domains based on accounts, partitions, objects, and/or the like.

When accessing the storage stamp 210, the web server 250 may provide an account name selected by the customer for accessing storage and is part of a DNS 230 host name. The account name DNS 230 translation may be used to locate a primary storage cluster and data center where the data is stored. The primary location is where all requests go to reach the data for that account. An application may use multiple account names to store its data across different locations. In conjunction with the account name, the partition name locates the data once a request reaches the storage cluster. The partition name is used to scale out access to the data across storage nodes based on traffic needs. When a partition name holds many objects, an object name identifies individual objects within that partition. The system may support atomic transactions across objects with the same partition name value. The object name may be optional since, for some types of data, the partition name uniquely identifies the object within the account.

Referring to FIG. 2, the storage stamp 210 may include a cluster of N racks of storage nodes, where each rack is built out as a separate fault domain with redundant networking and power. The storage stamp 210 may have its own virtual IP address (VIP 211). Clusters may range from 10 to 20 racks with 18 disk-heavy storage nodes per rack, but embodiments are not limited thereto. The location service 240 may manage the storage stamps. The location service 240 may be responsible for managing the account namespace across all stamps. The location server 240 may allocate accounts to storage stamps and manages them across the storage stamps for disaster recovery and load balancing. The location service 240 itself may be distributed across more than one geographic locations for its own disaster recovery.

The stream layer 214 may store the bits on disk and is in charge of distributing and replicating the data across many servers to keep data durable within the storage stamp 210. The stream layer 214 can be a distributed file system layer within a stamp. The stream layer 214 understands files, referred to as streams which are ordered lists of large storage chunks referred to as extents, how to store files, how to replicate files, and the like, but the stream layer 210 may not understand higher level object constructs or their semantics. The data is stored in the stream layer 214, but it is accessible from the partition layer 213. For example, partition servers (daemon processes in the partition layer 213) and stream servers may be co-located on each storage node in a stamp.

The partition layer 213 is built for (a) managing and understanding higher level data abstractions (blob, table, queue), (b) providing a scalable object namespace, (c) providing transaction ordering and strong consistency for objects, (d) storing object data on top of the stream layer, and (e) caching object data to reduce disk I/O. Another responsibility of the partition layer 213 is to achieve scalability by partitioning all of the data objects within a stamp. As described earlier, all objects have a partition name and may be broken down into disjointed ranges based on the partition name values and served by different partition servers. The partition layer 213 manages which partition server is serving what partition name ranges for blobs, tables, and queues. In addition, the partition layer 213 provides automatic load balancing of partition names across the partition servers to meet the traffic needs of the objects.

The front-end (FE) layer 212 may include a set of stateless servers that take incoming requests from web server 250. Upon receiving a request, the front end layer 212 may look up the account name, authenticate and authorize the request, and route the request to a partition server in the partition layer 213 (based on the partition name). The system may maintain a partition map that keeps track of the partition name ranges and which partition server is serving which partition names. For example, an FE server may cache the partition map and use the partition map to determine which partition server to forward each request to. The FE server may also stream large objects directly from the stream layer 214 and cache frequently accessed data for efficiency.

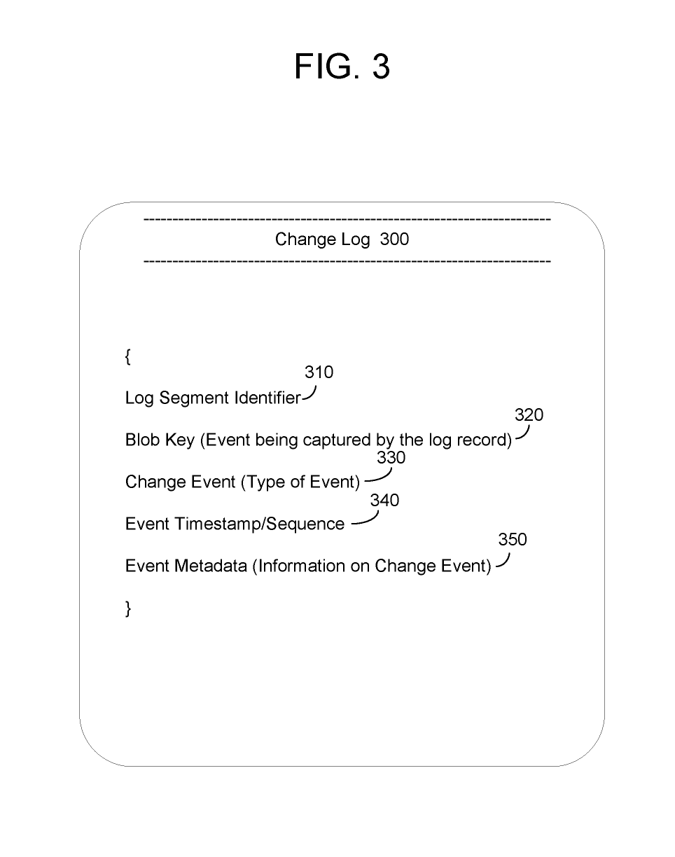

FIG. 3 illustrates an example of a log file 300 according to some embodiments. The example of the log file 300 shown in FIG. 3 is a generalized example, and is not to be construed as limiting the scope of the log file 300. The log file 300 may store a plurality of attributes having values which may be tracked via the log file 300 and used to create notifications about blobs/objects within a blob storage. The attributes may have values (e.g., integer, string, array, etc.) that can be inserted and updated by the system as changes are made. In some embodiments, the log file 300 is an internal file that is not made available to clients and subscribers of the system. As another example, the log file 300 may be made available in some cases. The cloud platform described herein may capture a log of changes to an object with some contextual information and store this information via the log file 300. The information stored within the log file 300 may be used to generate and provide push notifications for changes to blobs created via a blob API used for reactive programming models. The log file 300 may be stored within a storage (e.g., blob storage, etc.) and may be managed by the storage.

The log file 300 may implement various semantics. For example, the log file 300 may provide data durability and consistency. When a transaction is successful, a change to a blob caused by the transaction may be tracked and loss of information can be prevented through the log file 300. Each blob/object where the event occurs in the cloud/partition may be identified by a segment identifier 310. The log file 300 may also include a blob key 320 identifying a name of a blob/account in which the event occurred and change event information 330 identifying a type of event (e.g., modify, add, delete, etc.) In some embodiments, the log file 300 may include a timestamp and/or an ordered sequence of changes 340 (e.g., if event i for key x happened before event j) the log file 300 may reflect this order. The log file 300 may also include numerous types of event metadata 350.

In some embodiments, the log segment identifier 310 may identify a data segment/partition (e.g., logical storage location, etc.) of the blob. The segment/partition information may identify a table or other storage which holds the blob and which is stored in the blob storage. The segments may live for the lifetime of the partition and then become immutable upon split or merge. All segments belonging to an account may reside on the same partitions as the blob table of the account. Live segments may have the same transaction load as a main table and hence may provide a basis for uniform partitioning parameters with respect to load-balancing. In some cases, a notion of dependency ordering of these segments may be implemented as partitions split and merge and is maintained by partition order fields of the log file 300.

The log sequence fields 340 may be used to determine a chronological order of the blob change with respect to other blob changes tracked within the cloud platform. The event metadata 350 may provide context, timing, an application, a publisher, a subscriber, acknowledgement information, and the like, associated with the blob event change. The event data may be captured by the system as changes are made and stored in the log file 300. Furthermore, the blob storage may read the log file 300 at a point in time, such as on-demand, periodically, after a condition/trigger, or the like, and identify or accumulate changes of a blob or an account and transmit the change(s) to one or more subscribers.

Although not shown in FIG. 3, the log file 300 may include additional information not shown such as specific partition information of the blob location, acknowledgement information (i.e., has a subscriber acknowledged receipt of a notification, etc.), and the like. In some embodiments, the log file 300 may track notifications (e.g., for blobs and files) to guarantee at least one delivery and order a resend of the notification if no acknowledgment is received. In this scenario, duplicate transmissions are allowable because the system just needs one response (one acknowledgment) to stop the transmission of all notifications and resends. Furthermore, it is allowed for the acknowledgments to be received out of order.

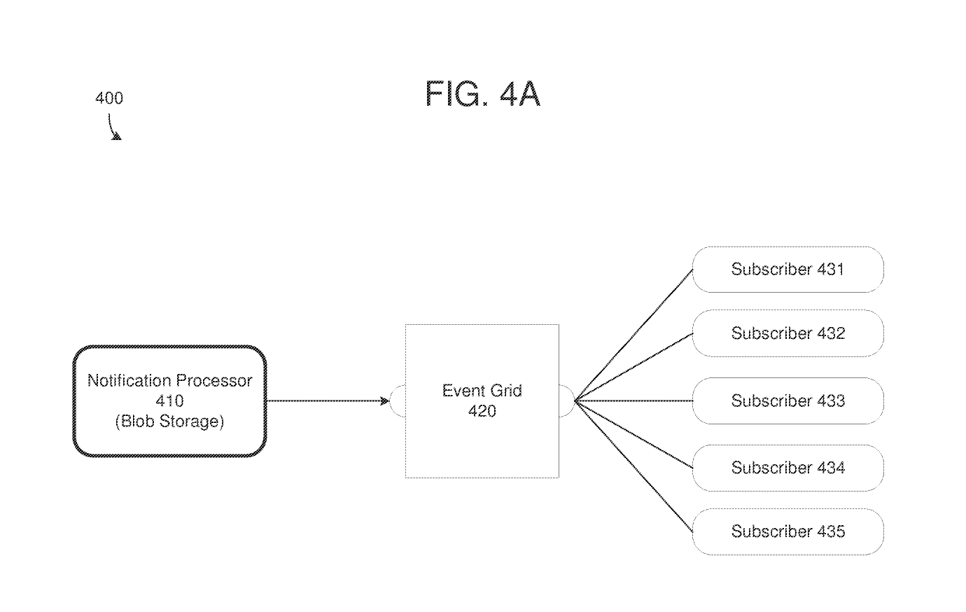

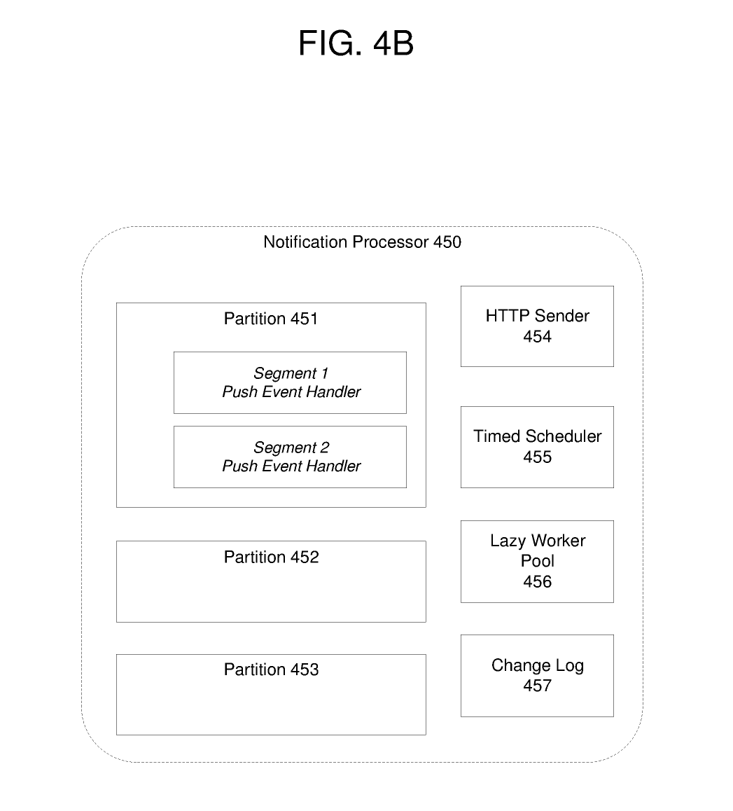

FIG. 4A illustrates publish-subscribe system 400 for transmitting notifications according to some embodiments, and FIG. 4B illustrates a notifications processor 410 within the public subscribe system 400 of FIG. 4A, according to some embodiments. Publish-subscribe system 400 allows applications to react to the creation, modification, and deletion of blobs using a server-less architecture. The system 400 may be implemented without the need for complicated code or expensive and inefficient polling services. For example, events generated by a blob storage and output through a notifications manger 410 of the blob storage may be pushed through to subscribers 431-435 such as functions, logic apps, custom http listeners, and the like, through an event grid 420.

In some embodiments, both the notification processor 410 and a change log for recording change information of blobs may be stored within the blob storage and may be used for reading and pushing notifications based on the change log to the event grid 420 which may push the notifications to the subscribers 431-435. Meanwhile, the event grid 420 which communicates with notification processor 410 may be a different service. The notification processor 410 may publish the changes as encoded messages to the event grid 420 via REST/HTTP APIs. The event grid 420 may be configured by the customer/client for routing and filtering notifications to one or more intended subscribers from the subscribers 431-435 when the notifications arrive at the event grid 420.

Blob storage events which may cause the notification processor 410 to create notifications may include image or video processing, search indexing, file-oriented workflows, and the like, which create modifications to blobs, deletions of blobs, and additions of blobs within the blob storage. Asynchronous file uploads are another example of an object addition event. When changes are infrequent but immediate responsiveness is necessary, event-based architecture such as publish-subscribe system 400 in FIG. 4A can be especially efficient. Blob storage events may occur in different types of accounts such as blob storage accounts, general purpose storage accounts, and the like. In this example, general purpose accounts are storage accounts that support all features for all storage services, including blobs, files, queues, tables, and the like. Meanwhile, a blob storage account is a specialized storage account for storing unstructured data as blobs (objects). Blob storage accounts are similar to general-purpose storage accounts in that they share durability, availability, scalability, and performance features including API consistency for block blobs and append blobs.

In order to establish blob change event notifications, the client may be interfaced via the event grid 420. Here, the client may instruct the event grid 420 to trap changes to a blob storage account X, and after the changes are trapped, use a configured routing table for forwarding notification triggers. The client may further configure the routing and filtering rules on the event grid 420. After the client registers, the event grid 420 may notify the blob storage that it wants to receive a notification for all the changes to account X (e.g., as a part of one time configuration, etc.) In response, the notification manager 410 may publish ‘change messages’ to a single destination (i.e., the event grid 420) through scoping/tagging the changes to the identified account X. The event grid 420 may be a routing proxy of the notifications. The notifications may be pushed by the notification processor 410 to the subscribers 431-435 via the event grid 420. The event grid 420 may send HTTP messages, trigger functions, and the like. Overall, the client is provided with a visible understanding of their underlying blob data which is more powerful than other cloud services.

FIG. 4B illustrates an example of the notification processor architecture 450 which may be implemented within a blob storage of a cloud platform. In this example, the notification processor architecture 450 has access to a plurality of partitions of data including partitions 461, 462, and 463 within the blob storage. Each partition may include a plurality of segments for storing blob objects, files, tables, and the like. Many blobs may be stored within each segment of each partition. The notification processor architecture 450 also includes a change log 457 for storing a log of changes with respect to blobs within the blob storage. In this example, the change log 457 is dedicated to multiple partitions, however, as another example, each partition may have its own change log, etc.

In this example, the notification processor architecture 450 includes an HTTP sender 454, a timed scheduler 455 and a lazy worker pool 456 in addition to the partitions 451-453 and the change log 457. The HTTP sender 454 may manage the http requests. For example, change notifications may be sent out as encoded messages over REST/HTTP. The HTTP sender 454 may manage http transport and scheduling of notifications to subscriber recipients. The timed scheduler 455 is an internal timer. When notifications occur with respect to a customer transaction, the notifications may be appended to the change log 457. In some embodiments, the notifications may be grouped into batches and the time scheduler may be a deadline scheduler to wait for a deadline upon seeing a change. Additionally, the time scheduler 455 may be used for other time based scheduling tasks such as timeouts, etc. The lazy worker pool 456 is a thread-pool to schedule all workers which process events within the architecture 450.

Each partition may include one or more segment push event handlers. The segment push event handler reacts to an event triggered internally. For example, in response to a change being detected the segment push event handler may run a state-machine or a workflow logic to handle the change such as by scheduling for later via a timer, etc. The segment push event handler may be per account within each partition, and therefore ma process events with respect to one account. In some embodiments, the segment push event handler may include a push state which keeps track of where the segment push event handler is at on the change log, checkpoint, forward, and error handling queues for messages, etc.

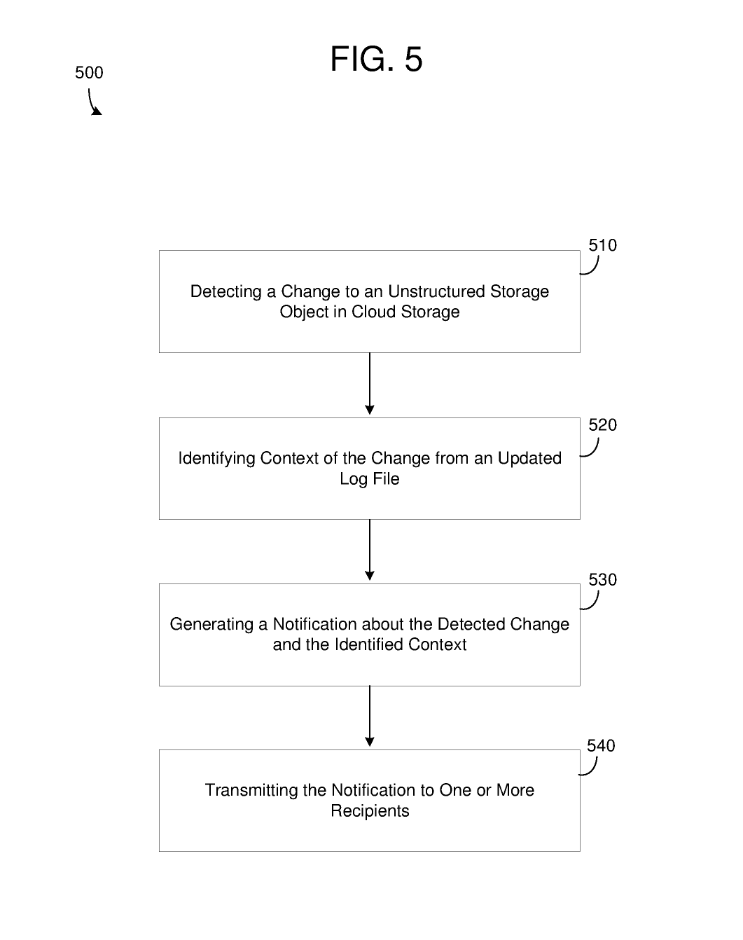

FIG. 5 illustrates a method 500 for generating and transmitting notifications for an object storage according to some embodiments. For example, a processing unit (e.g., one or more processors, processing cores, processor threads, etc.) of a data server may execute software program code to cause a data server or cloud server to perform the method 500. For example, the method 500 and all other methods and processes herein may be embodied in computer-executable program code that may be read from one or more non-transitory computer-readable media, such as a flash drive, a CD-ROM, a DVD-ROM, an external disk, a magnetic tape, or the like, and then stored in a compressed, uncompiled and/or encrypted format. In some embodiments, hard-wired circuitry may be used instead of, or in combination with program code to implement the methods and processes. Embodiments are not limited to any specific combination of hardware and software.

Referring to FIG. 5, in 510, the method may include detecting a change within a cloud storage based on an unstructured storage object stored in the cloud storage. For example, the change that is detected may include a modification to an existing unstructured data object, an addition or creation of a new unstructured data object, a deletion of an existing unstructured data object, and the like. The object may be a blob or other type of unstructured object. The change may be implemented through an API of a blob storage that stores the object. In some embodiments, the cloud storage may store and manage a log file which includes an identification of changes made to blobs or other objects that are stored within the storage. The log file may also include metadata of changes, acknowledgement information, event information, partition information of the blob, and the like. In some embodiments, the detecting may include reading an event state of the unstructured storage object stored within the log file to detect the change to the unstructured storage object.

In 520, the method may include identifying contextual attributes of the change to the object from an updated state of the log file that stores information about the unstructured storage object. The contextual attributes may identify a type of change, an account or user associated with the change, an updated storage location of the object within a partition of the storage, a chronological order of the change with respect to other changes, and the like. For example, the log file may include an append-only log file that stores a chronological order of changes to blobs within a multi-tenant blob storage which are detected from the blob storage. The log file may include an identification of a location of the blob storage within a partition layer, an account associated with the blob, an event type of the change, a timestamp of the change, metadata further describing the change, and the like.

In 530, the method may include generating a notification that indicates the detected change and the identified contextual attributes of the detected change, and in 540, the method may include transmitting the generated notification message to one or more recipients associated with the unstructured storage object. The notification may be generated on-demand in response to each detected change to each detected blob or other unstructured object. As another example, a notification may be generated when a predetermined threshold of changes of been detected, at periodic frequencies or intervals, randomly, or the like. Furthermore, different subscribers to a same account/blob may have different notification policies and may be notified at different intervals.

In some embodiments, the transmitting may include transmitting the notification to one or more of a subscriber device, a software application, and the like. The notifications may be transmitted via an at-least-once-transmission that continues until the application acknowledges receipt of the notification and that is stored in the log file making it resilient to failure. In some embodiments, the method may include enabling an account or a blob for notifications in response to a request from a client. The method may further include registering the one or more recipients as subscribers for receiving change notifications for the unstructured storage object. In some cases, the client may also be a subscriber.

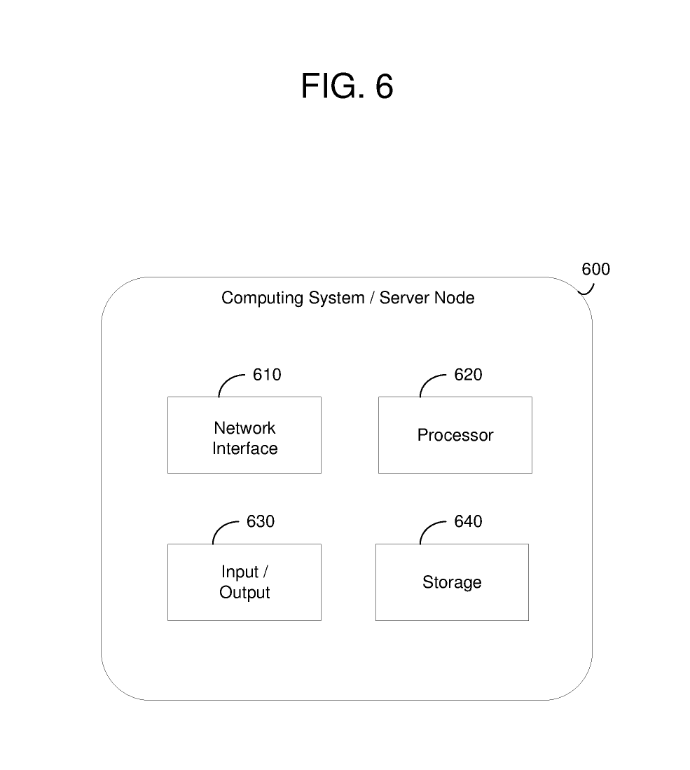

FIG. 6 illustrates an example of a computing node architecture 600 according to some embodiments. For example, the computing system 600 may be a server node, a cloud data center, a database, a user device, or the like. In some embodiments, the computing system 600 may be distributed across multiple devices. Referring to FIG. 6, the computing system 600 includes a network interface 610, a processor 620, an input/output 630, and a storage device 640. Although not shown in FIG. 6, the computing system 600 may also include or be electronically connected to other components such as a display, a receiver, a transmitter, a persistent disk, and the like. The processor 620 may control the other components of the computing system 600.

The network interface 610 may transmit and receive data over a network such as the Internet, a private network, a public network, an enterprise network, and the like. The network interface 610 may be a wireless interface, a wired interface, or a combination thereof. The processor 620 may include one or more processing devices each including one or more processing cores. In some examples, the processor 620 is a multicore processor or a plurality of multicore processors. Also, the processor 620 may be fixed or it may be reconfigurable.

The input and the output 630 may include interfaces for inputting data to the computing system 600 and for outputting data from the computing system. For example, data may be output to an embedded or an external display, a storage drive, a printer, and the like. For example, the input and the output 630 may include one or more ports, interfaces, cables, wires, boards, and/or the like, with input/output capabilities. The network interface 610, the output 630, or a combination thereof, may interact with applications executing on other devices.

The storage device 640 is not limited to a particular storage device and may include any known memory device such as RAM, ROM, hard disk, object storage, blob storage, and the like, and may or may not be included within the cloud environment. The storage 640 may include partitions of storage and one or more indexes identifying location of stored objects. The storage 640 may store software modules or other instructions which can be executed by the processor 620 to perform the method 500 shown in FIG. 5.

Referring to FIG. 6, the storage 640 may store a log file for cloud storage which tracks changes such as modifications, additions, and deletions of blobs within a blob storage. According to various embodiments, the processor 620 may detect a change within the cloud storage based on an unstructured storage object stored in the cloud storage. For example, the processor 620 may identify contextual attributes of the change from an updated state of the log file stored in the storage 640 and which stores information about the unstructured storage object. In response, the processor 620 may generate a notification that indicates the detected change and the identified contextual attributes of the detected change, and transmit the generated notification message to one or more recipients associated with the unstructured storage object. For example, the processor 620 may transmit the notification to a software application that subscribes to the account associated with the modified object. As another example, the processor 620 may control the network interface 610 to transmit the notification to another device or system via a network such as the Internet.

For example, the change to the object may include at least one of a creation of a new unstructured storage object, a modification of an existing unstructured storage object, a deletion of an existing unstructured storage object, or the like. The change, the location of the object being changed, metadata of the change, and the like, may be stored as an event within the log file. Also, context of the change may be stored. The context may be identified from metadata or a state of the object before and/or after the change. In some embodiments, the processor 620 may read an event state of the unstructured storage object stored within the log file to detect the change to the unstructured storage object. The event state may identify a type of change that occurred with the respect to the object (e.g., modify, add, delete, etc.). The log file may include an append-only log file that stores a chronological order of changes detected to a plurality of unstructured storage objects stored in the cloud storage.

In some embodiments, the processor 620 may transmit the notification to a software application via an at least once transmission that continues until the software application acknowledges receipt of the notification. In some embodiments, the processor 620 may push the notification to one or more subscriber recipients via an event grid or through another storage file or object. Whether the acknowledgment has been received may be tracked via the log file. Here, the processor 620 may continue to read the log file and transmit the notification until the log file is updated to reflect receipt of the acknowledgment. In some embodiments, the processor 620 may register the one or more recipients as subscribers that receive change notifications for the unstructured storage object.

The above-described diagrams represent logical architectures for describing processes according to some embodiments, and actual implementations may include more or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of network(s) and/or a dedicated connection. Each component or device may comprise any number of hardware and/or software elements suitable to provide the functions described herein as well as any other functions.

Embodiments described herein are solely for the purpose of illustration. Those in the art will recognize other embodiments may be practiced with modifications and alterations to that described above.

What is claimed is:

1. A computing system comprising:
a storage configured to store a log file for a cloud storage; and
a processor configured to
detect a change within the cloud storage based on an unstructured storage object stored in the cloud storage,
identify contextual attributes of the change from an updated state of the log file that stores information about the unstructured storage object,
generate a notification that indicates the detected change and the identified contextual attributes of the detected change, and
transmit the generated notification message to one or more recipients associated with the unstructured storage object.

2. The computing system of claim 1, wherein the processor is configured to detect at least one of a creation of the unstructured storage object, a modification of the unstructured storage object, and a deletion of the unstructured storage object.

3. The computing system of claim 1, wherein the processor is configured to read an event state of the unstructured storage object stored within the log file to detect the change to the unstructured storage object.

4. The computing system of claim 1, wherein the log file comprises an append-only log file that stores a chronological order of changes detected to a plurality of unstructured storage objects stored in the cloud storage.

5. The computing system of claim 1, wherein the processor is configured to repeatedly transmit the notification to a software application recipient via an at least once transmission that continues until the software application acknowledges receipt of the notification.

6. The computing system of claim 1, wherein the processor is configured to push the notification as an event to one or more subscriber recipients via an event grid.

7. The computing system of claim 1, wherein the processor is further configured to register the one or more recipients as subscribers of change notifications with respect to the unstructured storage object.

8. The computing system of claim 1, wherein the contextual attributes indicate one or more of an identification of the unstructured storage object, a location of the unstructured storage object within the cloud storage, a type of storage event, and a timestamp at which the storage event occurred.

9. A method comprising:
detecting a change within a cloud storage based on an unstructured storage object stored in the cloud storage;
identifying contextual attributes of the change from an updated state of a log file that stores information about the unstructured storage object;
generating a notification that indicates the detected change and the identified contextual attributes of the detected change; and
transmitting the generated notification message to one or more recipients associated with the unstructured storage object.

10. The method of claim 9, wherein the detecting comprises detecting at least one of a creation of the unstructured storage object, a modification of the unstructured storage object, and a deletion of the unstructured storage object.

11. The method of claim 9, wherein the detecting comprises reading an event state of the unstructured storage object stored within the log file to detect the change to the unstructured storage object.

12. The method of claim 9, wherein the log file comprises an append-only log file that stores a chronological order of changes detected to a plurality of unstructured storage objects stored in the cloud storage.

13. The method of claim 9, wherein the transmitting comprises transmitting the notification to a software application via an at least once transmission that continues until the software application acknowledges receipt of the notification.

14. The method of claim 9, wherein the transmitting comprises pushing the notification as an event to one or more subscriber recipients via an event grid.

15. The method of claim 9, wherein the method further comprises registering the one or more recipients as subscribers of change notifications with respect to the unstructured storage object.

16. The method of claim 9, wherein the contextual attributes indicate one or more of an identification of the unstructured storage object, a location of the unstructured storage object within the cloud storage, a type of storage event, and a timestamp at which the storage event occurred.

17. A non-transitory computer-readable storage medium storing program instructions that when executed cause a processor to perform a method comprising:
detecting a change within a cloud storage based on an unstructured storage object stored in the cloud storage;
identifying contextual attributes of the change from an updated state of a log file that stores information about the unstructured storage object;
generating a notification that indicates the detected change and the identified contextual attributes of the detected change; and
transmitting the generated notification message to one or more recipients associated with the unstructured storage object.

18. The non-transitory computer readable medium of claim 17, wherein the detecting comprises detecting at least one of a creation of the unstructured storage object, a modification of the unstructured storage object, and a deletion of the unstructured storage object.

19. The non-transitory computer readable medium of claim 17, wherein the detecting comprises reading an event state of the unstructured storage object stored within the log file to detect the change to the unstructured storage object.

20. The non-transitory computer readable medium of claim 17, wherein the log file comprises an append-only log file that stores a chronological order of changes detected to a plurality of unstructured storage objects stored in the cloud storage.
